(19) United States
(12) Patent Application Publication
(10) Pub. No.: US 2009/0197028 A1
(43) Pub. Date: Aug. 6, 2009

(54) Fluoropolymers of tetrafluoroethylene and 3,3,3-trifluoropropylene

(76) Inventors: Donald F. Lyons, Wilmington, DE (US); Steven R. Oriani, Landenberg, PA (US); Ronald D. Stevens, Norton, OH (US)

Correspondence Address: DUPONT PERFORMANCE ELASTOMERS L.L.C., PATENT RECORDS CENTER, 4417 LANCASTER PIKE, BARLEY MILL PLAZA P25, WILMINGTON, DE, 19805, US

(21) Appl. No.: 12/012,069

(22) Filed: Jan. 31, 2008

(51) Int. Cl. C08F 14/18; C08F 14/22; C08F 14/24; C08F 14/26; C08F 14/28; C08F 2/20; B29D 23/00

(52) U.S. Cl. 428/36.6; 526/255; 526/247; 526/249; 526/87

(57) ABSTRACT

Copolymer comprising at least 50 mol percent up to 85 mol percent tetrafluoroethylene (TFE), from 10-35 mol percent 3,3,3-trifluoropropylene (TFP), and from 0.5-15 mol percent of a fluorinated ethylenically unsaturated monomer of the formula RCF═CR₂ wherein R, which can be the same or different, is selected from the group consisting of H, F, Cl, Br, I, alkyl of from 1 to 8 carbon atoms, perfluoroalkyl of from 1 to 8 carbon atoms, and perfluoroalkylether of from 1 to 8 carbon atoms are useful as process aids and for fuel barrier applications in flexible hose constructions.

### FIELD OF THE INVENTION

This invention relates to fluoropolymers of tetrafluoroethylene (TFE) and 3,3,3-trifluoropropylene (TFP) with an effective amount of at least one other monomer and to their use to achieve improved permeation resistance to hydrocarbon fuels coupled with good adhesion to rubber substrates.

### BACKGROUND OF THE INVENTION

Partially fluorinated polymers, i.e., fluoropolymers, are of interest because they combine desirable low permeability performance with low processing temperatures. Dipolymers of tetrafluoroethylene (TFE) and 3,3,3-trifluoropropylene (TFP), for example, have been proposed for use as barrier layers. Preparation of these dipolymers is described in U.S. patent application Ser. No. 11/712,252. However, their utility as a barrier resin is limited due to low tack, or adhesion, to other substrates, i.e., performance as a barrier liner is limited. In addition, these dipolymers often exhibit a glass transition temperature that is undesirably high for use at a given fluorine content. Therefore, a technique that will improve tack and adhesion of TFE/TFP based polymers without altering their barrier performance is needed.

### SUMMARY OF THE INVENTION

One aspect of the present invention concerns copolymers consisting essentially of at least 50 mol percent tetrafluoroethylene (TFE), from 10-35 mol percent 3,3,3-trifluoropropylene (TFP), and from 0.5-15 mol percent of at least one other fluorinated ethylenically unsaturated monomer of the formula RCF═CR₂ wherein R, which can be the same or different, is selected from the group consisting of H, F, Cl, Br, I, alkyl of from 1 to 8 carbon atoms, perfluoroalkyl of from 1 to 8 carbon atoms, and perfluoroalkylether of from 1 to 8 carbon atoms.

Another aspect of this invention concerns the use of the above-defined copolymers as barrier layers in fuel containment applications, such as a liner in flexible hose constructions, wherein the copolymers are as defined above with the result that the copolymers adhere well to butadiene acrylonitrile (NBR) rubber.

Another aspect of the invention concerns the use of the above-defined copolymers as process aid additives for non-fluorinated thermoplastics, i.e., imparting improved extrusion processability for non-fluorinated polar and melt-extrudable, i.e., melt-processable, polymers.

Another aspect of the invention concerns melt-processable compositions comprising 25 parts per million to 50% by weight of a copolymer as defined above.

Another aspect of this invention concerns a process for preparing copolymers as defined above by emulsion polymerization.

The presence of an effective amount of at least one other fluorinated ethylenically unsaturated monomer according to the invention unexpectedly improves the ability of the TFE/TFP dipolymer to adhere to a range of hydrocarbon substrates, particularly NBR rubber substrates, as well as improving other properties.

### DETAILED DESCRIPTION OF THE INVENTION

The present invention is directed to fluorine-containing copolymers that have excellent processability and exhibit excellent hydrocarbon fuel barrier properties. These fluorine-containing polymers are amorphous or semi-crystalline. Amorphous polymers do not exhibit a melt point, whereas semi-crystalline polymers do exhibit a melt point.

The fluoropolymers of the invention comprise copolymerized units of tetrafluoroethylene (TFE), 3,3,3-trifluoropropylene (TFP), and at least one other fluorinated ethylenically unsaturated monomer of the structure RCF═CR₂ wherein R, which can be the same or different, is selected from the group consisting of H, F, Cl, Br, I, alkyl of from 1 to 8 carbon atoms, perfluoroalkyl of from 1 to 8 carbon atoms, and perfluoroalkylether of from 1 to 8 carbon atoms. Preferably the fluoropolymers contain at least 50 (most preferably 70-85) mole percent of TFE, between 10 and 30 (most preferably 15-30) mole percent TFP, and 0.5-15 (most preferably 0.5-10) mole percent of an ethylenically unsaturated monomer of the formula RCF═CR₂ wherein R is selected from H, F, Cl, Br, I, alkyl of from 1 to 8 carbon atoms, perfluoroalkyl of from 1 to 8 carbon atoms, or perfluoroalkylether of from 1 to 8 carbon atoms.

Representative examples of fluorinated ethylenically unsaturated monomers of the structure RCF═CR₂ include, but are not limited to, vinylidene fluoride (VF2), hexafluoropropylene (HFP), perfluoro(alkyl vinyl ethers), perfluoro(8-cyano-5-methyl-3,6-dioxa-1-octene), perfluorobutyl ethylene, chlorotrifluoroethylene, 1-hydropentafluoropropylene, 2-hydropentafluoropropylene, bromotrifluoroethylene, iodotrifluoroethylene, 4-bromo-3,3,4,4-tetrafluorobutene, 4-iodo-3,3,4,4-tetrafluorobutene, and mixtures thereof.

Perfluoro(alkyl vinyl) ethers (PAVE) suitable for use as monomers according to the invention include those of the formula (I)

CF₂═CFO(R_{f′}O)ₙ(R_{f″}O)ₘR_{f} (I)

where R_{f′}, and R_{f″}, are different linear or branched perfluoroalkylene groups of 2-6 carbon atoms, m and n are independently 0-10, and R_{f} is a perfluoroalkyl group of 1-6 carbon atoms.

A preferred class of perfluoro(alkyl vinyl) ethers includes compositions of the formula (II)

CF₂═CFO(CF₂CFXO)ₙR_{f} (II)

where X is F or CF₃, n is 0-5, and R_{f} is a perfluoroalkyl group of 1-6 carbon atoms.

A most preferred class of perfluoro(alkyl vinyl) ethers for economy and ease of processing includes those ethers wherein n is 0 or 1 and R_{f} contains 1-3 carbon atoms. Examples of such perfluorinated ethers include perfluoro(methyl vinyl) ether (PMVE) and perfluoro(propyl vinyl) ether (PPVE). Other useful perfluoro(alkyl vinyl) ether monomers include compounds of the formula (III)

CF₂═CFO[(CF₂)ₘCF₂CFZO]ₙR_{f} (III)

where R_{f} is a perfluoroalkyl group having 1-6 carbon atoms, m=0 or 1, n=0-5, and Z═F or CF₃. Preferred members of this class are those in which R_{f} is C₃F₇, m=0, and n=1.

Additional perfluoro(alkyl vinyl) ether monomers include compounds of the formula (IV)

CF₂═CFO[(CF₂CF{CF₃}O)ₙ(CF₂CF₂CF₂O)ₘ(CF₂)ₚ]CₓF₂ₓ₊₁ (IV)

where m and n independently=0-10, p=0-3, and x=1-5. Preferred members of this class include compounds where n=0-1, m=0-1, and x=1.

Other examples of useful perfluoro(alkyl vinyl ethers) include compounds of the formula (V)

CF₂═CFOCF₂CF(CF₃)O(CF₂O)ₘCₙF₂ₙ₊₁ (V)

wherein=1-5, m=1-3, and where, preferably, n=1.

The polymers of this invention can conveniently be prepared by semi-batch emulsion polymerization in which a first gaseous monomer mixture is introduced into a reactor that contains an aqueous solution. The reactor is typically not completely filled with the aqueous solution, so that a vapor space remains. The aqueous solution may optionally comprise a fluorosurfactant dispersing agent, such as ammonium perfluorooctanoate, ammonium 3,3,4,4-tetrahydrotridecafluorooctanoate, Zonyl® FS-62 (available from DuPont) or Zonyl® 1033D (available from DuPont). Optionally the aqueous solution may contain a pH buffer, such as a phosphate or acetate buffer, for controlling the pH of the polymerization reaction. Instead of a buffer, a base, such as NaOH, NH₄OH, or CsOH may be used to control pH. Alternatively, or additionally, a pH buffer or base may be added to the reactor at various times throughout the polymerization reaction, either alone or in combination with other ingredients, such as, for example, a polymerization initiator or chain transfer agent (described in greater detail below).

The initial aqueous solution may contain a polymerization initiator, such as a water-soluble inorganic peroxide or an organic peroxide. Suitable peroxides include hydrogen peroxide, ammonium persulfate (or other persulfate salt), di-tertiary butyl peroxide, disuccinic acid peroxide, and tertiary butyl peroxyisobutyrate. The initiator may also be a combination of an inorganic peroxide and a reducing agent, such as the combination of ammonium persulfate and ammonium sulfite.

The amount of the first gaseous monomer mixture charged to the reactor (sometimes referred to as “initial charge”) is set so as to result in a reactor pressure between 0.3 MPa and 10 MPa (preferably between 0.3 and 3 MPa). By way of example, the composition of the first gaseous monomer mixture may consist of 95-100 mole percent TFE and 0-5 mol percent TFP. In the case of TFP, if the initial monomer charge contains greater than 5 mol percent TFP, the polymerization rate can be uneconomically slow or the reactor will have to be pressurized in excess of 10 MPa, which may lead to safety issues. Any other monomer within the scope of the invention, such as, for example, up to 5 mole percent VF₂, may be used in place of TFP in the first gaseous mixture depending on the copolymer end product that is desired.

The first gaseous monomer mixture is dispersed in the aqueous solution while the reaction mixture is agitated, typically by mechanical stirring. The resulting mixture is termed a reaction mixture.

As noted above, a chain transfer agent may be employed in the polymerization process for preparing the compounds of this invention to control the average molecular weight of the polymer. The entire amount of chain transfer agent may be added at one time, or addition may be spread out over time, up to the point when 100 percent of the second gaseous monomer mixture (as defined hereinafter) has been added to the reactor. Typical chain transfer agents include low molecular weight hydrocarbons, such as ethane, propane, and pentane, and halogenated compounds, such as carbon tetrachloride, chloroform, iodotridecafluorohexane, 1,4-diiodooctafluorobutane. One skilled in the art can envision many other chain transfer agents that can be used in this process. If a chain transfer agent is employed, fragments of the agent will typically become end groups of the TFE/TFP copolymer.

The temperature of the semi-batch reaction mixture is maintained in the range of 25° C.-130° C., preferably 30° C.-90° C., throughout the polymerization process. Polymerization begins when the initiator either thermally decomposes or reacts with reducing agent, and the resulting radicals react with dispersed monomer to form a polymer dispersion.

Additional quantities of the monomers (referred to herein as the “second gaseous monomer mixture” or “incremental monomer mixture feed”) are added at a controlled rate throughout the polymerization process in order to maintain a desired reactor pressure at a controlled temperature. The relative ratio of the monomers in the second gaseous monomer mixture is set to be approximately the same as the desired ratio of copolymerized monomer units in the resulting fluoropolymer Thus, the second gaseous monomer mixture consists of at least 50 mole percent, based on the total moles of monomers in the monomer mixture, of TFE, between 10 and 30 (preferably 15-30) mole percent of TFP, and 0.5-15 (preferably 0.5-10) mole percent of at least one other ethylenically unsaturated monomer of the formula RCF═CR2 wherein R, which can be the same or different, is selected from H, F, Cl, Br, I, alkyl of from 1 to 8 carbon atoms, perfluoroalkyl of from 1 to 8 carbon atoms, or perfluoroalkylether of from 1 to 8 carbon atoms. Additional chain transfer agent may, optionally, be continued to be added to the reactor at any point during this stage of the polymerization process. Additional fluorosurfactant and polymerization initiator may also be fed to the reactor during this stage.

The amount of copolymer formed is approximately equal to the cumulative amount of the second gaseous monomer mixture fed to the reactor. One skilled in the art will recognize that the molar ratio of monomers in the second gaseous monomer mixture is not necessarily exactly the same as that of the desired copolymerized monomer unit composition in the resulting copolymer because the composition of the first gaseous monomer charge may not be exactly that required for the desired final polymer composition or because a portion of the monomers in the second gaseous monomer mixture may dissolve, without reacting, into the polymer particles already formed.

Total polymerization times in the range of from 2 to 30 hours are typical in a semi-batch polymerization process of this type.

The resulting copolymer dispersion may be isolated, filtered, washed, and dried by conventional techniques employed in the fluoropolymer manufacturing industry. See, for example, Ebnesajjad, S., “Fluoroplastics, Vol. 2: Melt Processible Fluoropolymers” Plastics Design Library, 2003.

### EXAMPLE 1

A TFE/TFP/HFP copolymer was prepared by an aqueous semi-batch emulsion polymerization process of the invention, carried out at 80° C. in a well-stirred reaction vessel. 24.0 kg of a 0.5 wt. % solution of perfluorohexylethylsulfonic acid was charged to a 33 L reactor and heated to 80° C. The reactor headspace was pressurized to 1.48 MPa with a first gaseous monomer mixture of 97 mole percent tetrafluoroethylene and 3 mole percent 3,3,3-trifluoropropene. Polymerization was commenced by adding 200 mL of a solution containing 7 wt. % ammonium persulfate/5 wt. % diammonium phosphate. The reactor pressure dropped in response to polymerization. Reactor pressure was maintained at 1.48 MPa by addition of a second gaseous monomer mixture of 85.4 mole percent tetrafluoroethylene, 12.6 mole percent 3,3,3-trifluoropropene, and 2.0 mole percent hexafluoropropylene. Additional 7 wt. % ammonium persulfate/5 wt. % diammonium phosphate solution was added to maintain the polymerization. After 8000 grams of the second gaseous monomer mixture were added to the reactor, the reactor was cooled and depressurized to stop the polymerization. Cycle time (time between introduction of initiator and when 8000 g of the second gaseous monomer mixture had been added) was 16.0 hours. A 24.36 wt. % solids latex was obtained. The copolymer was coagulated by addition of calcium nitrate and dried.

### EXAMPLE 2

A TFE/TFP/PMVE copolymer was prepared by an aqueous semi-batch emulsion polymerization process of the invention, carried out at 80° C. in a well-stirred reaction vessel. 24.0 kg of a 0.5 wt. % solution of perfluorohexylethylsulfonic acid was charged to a 33 L reactor and heated to 80° C. The reactor headspace was pressurized to 1.48 MPa with a first gaseous monomer mixture of 97 mole percent tetrafluoroethylene and 3 mole percent 3,3,3-trifluoropropene. Polymerization was commenced by adding 200 mL of a solution containing 7 wt. % ammonium persulfate/5 wt. % diammonium phosphate. The reactor pressure dropped in response to polymerization. Reactor pressure was maintained at 1.48 MPa by addition of a second gaseous monomer mixture of 85.6 mole percent tetrafluoroethylene, 12.6 mole percent 3,3,3-trifluoropropene, and 1.8 mole percent perfluoro(methyl vinyl ether). Additional 7 wt. % ammonium persulfate/5 wt. % diammonium phosphate solution was added to maintain the polymerization. After 8000 grams of the second gaseous monomer mixture were added to the reactor, the reactor was cooled and depressurized to stop the polymerization. Cycle time (time between introduction of initiator and when 8000 g of the second gaseous monomer mixture had been added) was 16.2 hours. A 25.33 wt. % solids latex was obtained. The copolymer was freeze coagulated and dried.

### EXAMPLE 3

A TFE/TFPNF₂ copolymer was prepared by an aqueous semi-batch emulsion polymerization process of the invention, carried out at 80° C. in a well-stirred reaction vessel. 24.0 kg of a 0.5 wt. % solution of perfluorohexylethylsulfonic acid was charged to a 33 L reactor and heated to 80° C. The reactor headspace was pressurized to 1.34 MPa with a first gaseous monomer mixture of 97 mole percent tetrafluoroethylene and 3 mole percent 3,3,3-trifluoropropene. Polymerization was commenced by adding 200 mL of a solution containing 7 wt. % ammonium persulfate/5 wt. % diammonium phosphate. The reactor pressure dropped in response to polymerization. Reactor pressure was maintained at 1.34 MPa by addition of a second gaseous monomer mixture of 83 mole percent tetrafluoroethylene, 15.5 mole percent 3,3,3-trifluoropropene, and 1.5 mole percent vinylidene fluoride. Additional 7 wt. % ammonium persulfate/5 wt. % diammonium phosphate solution was added to maintain the polymerization. After 8000 grams of the second gaseous monomer mixture were added to the reactor, the reactor was cooled and depressurized to stop the polymerization. Cycle time (time between introduction of initiator and when 8000 g of the second gaseous monomer mixture had been added) was 16.5 hours. A 25.30 wt. % solids latex was obtained. The copolymer was freeze coagulated and dried.

### EXAMPLE 4

A TFE/TFP/BTFB copolymer was prepared by an aqueous semi-batch emulsion polymerization process of the invention, carried out at 80° C. in a well-stirred reaction vessel. 24.0 kg of a 0.5 wt. % solution of perfluorohexylethylsulfonic acid was charged to a 33 L reactor and heated to 80° C. The reactor headspace was pressurized to 1.34 MPa with a first gaseous monomer mixture of 97 mole percent tetrafluoroethylene and 3 mole percent 3,3,3-trifluoropropene. Polymerization was commenced by adding 200 mL of a solution containing 7 wt. % ammonium persulfate/5 wt. % diammonium phosphate. The reactor pressure dropped in response to polymerization. Reactor pressure was maintained at 1.34 MPa by addition of a second gaseous monomer mixture of 84.5 mole percent tetrafluoroethylene, and 15.5 mole percent 3,3,3-trifluoropropene. Additional 7 wt. % ammonium persulfate/5 wt. % diammonium phosphate solution was added to maintain the polymerization. After 50.0 grams of the second gaseous monomer mixture had been added, feed of 4-bromo-3,3,4,4-tetrafluorobutene (BTFB) commenced. Feed of BTFB was discontinued after 7500 grams of the second gaseous monomer mixture had been fed, for a total of 250.0 grams BTFB. After 8000 grams of the second gaseous monomer mixture were added to the reactor, the reactor was cooled and depressurized to stop the polymerization. Cycle time (time between introduction of initiator and when 8000 g of the second gaseous monomer mixture had been added) was 20.2 hours. A 25.43 wt. % solids latex was obtained. The copolymer was freeze coagulated and dried. The bromine content of the isolated polymer was 1.08 weight percent.

### EXAMPLE 5

A TFE/TFP/8-CNVE copolymer was prepared by an aqueous semi-batch emulsion polymerization process of the invention, carried out at 80° C. in a well-stirred reaction vessel. 24.0 kg of a 0.5 wt. % solution of perfluorohexylethylsulfonic acid was charged to a 33 L reactor and heated to 80° C. The reactor headspace was pressurized to 1.34 MPa with a first gaseous monomer mixture of 97 mole percent tetrafluoroethylene and 3 mole percent 3,3,3-trifluoropropene. Polymerization was commenced by adding 200 mL of a solution containing 7 wt. % ammonium persulfate/5 wt. % diammonium phosphate. The reactor pressure dropped in response to polymerization. Reactor pressure was maintained at 1.34 MPa by addition of a second gaseous monomer mixture of 84.5 mole percent tetrafluoroethylene, and 15.5 mole percent 3,3,3-trifluoropropene. Additional 7 wt. % ammonium persulfate/5 wt. % diammonium phosphate solution was added to maintain the polymerization. After 50.0 grams of the second gaseous monomer mixture had been added, feed of perfluoro(8-cyano-5-methyl-3,6,dioxa-1-octene) (8-CNVE) commenced. Feed of 8-CNVE was discontinued after 7500 grams of the second gaseous monomer mixture had been fed, for a total of 250.0 grams 8-CNVE. After 8000 grams of the second gaseous monomer mixture were added to the reactor, the reactor was cooled and depressurized to stop the polymerization. Cycle time (time between introduction of initiator and when 8000 g of the second gaseous monomer mixture had been added) was 18.0 hours. A 24.93 wt. % solids latex was obtained.

The copolymers of this invention are useful in many industrial applications including molded plastic products, coatings, and as process aid additives for non-fluorinated thermoplastics, i.e., compositions comprising copolymers of this invention provide improved extrusion processability of non-fluorinated polar and melt-extrudable, i.e., melt-processable, polymers having commercial value in a variety of extruded shaped articles. Examples of non-fluorinated melt-processable polymers usefully according to the invention include, but are not limited to, hydrocarbon resins, chlorinated polyethylene, and polyvinyl chloride. The term “non-fluorinated” is used herein to mean that the ratio of fluorine atoms to carbon atoms present in the polymer is less than 1:1.

Other examples of non-fluorinated melt-processable polymers that can benefit from fluorine-containing copolymers according to the invention include hydrocarbon polymers having melt indexes (measured according to ASTM D1238 at 190° C., using a 2160 g weight) of 50.0 g/10 minutes or less, preferably 20.0 g/10 minutes or less, and especially less than 5.0 g/10 minutes. The melt-processable polymers may be elastomeric copolymers of ethylene, propylene, and optionally a non-conjugated diene monomer, for example 1,4-hexadiene. In general, such hydrocarbon polymers also include any thermoplastic hydrocarbon polymer obtained by the homopolymerization or copolymerization of a monoolefin of the formula CH₂═CHR, where R is H or an alkyl radical, usually of not more than eight carbon atoms. In particular, this invention is applicable to polyethylene, of both high density and low density, for example, polyethylenes having a density within the range 0.85 to 0.97 g/cm³; polypropylene; polybutene-1; poly(3-methylbutene); poly(methylpentene); and copolymers of ethylene and alpha-olefins such as propylene, butene-1, hexene-1, octene-1, decene-1, and octadecene. Hydrocarbon polymers may also include vinyl aromatic polymers such as polystyrene and co-polymers of styrene and butadiene or isoprene. Because specific hydrocarbon polymers exhibit differing melt characteristics, the practice of this invention may have greater utility in some hydrocarbon polymers than in others. Thus, hydrocarbon polymers such as polypropylene and branched polyethylene that are not of high molecular weight have favorable melt flow characteristics even at lower temperatures, so that surface roughness, die build-up, or excessive die pressures can be avoided by adjusting extrusion conditions. These hydrocarbon polymers may only require the use of a fluorocarbon polymer extrusion aid according to the invention under unusual and exacting extrusion conditions. However, other polymers, such as high molecular weight, high density polyethylene, linear low density polyethylene copolymers, high molecular weight polypropylene, and propylene copolymers with other olefins, particularly those with narrow molecular weight distributions, do not permit this degree of freedom in variation of extrusion conditions. It is particularly with these resins that improvements in the surface quality of the extruded product or reductions in die pressure are obtained by using the fluoropolymers of tetrafluoroethylene (TFE) and 3,3,3-trifluoropropylene (TFP) described herein according to this invention.

Other non-fluorinated melt-processable polymers that may benefit from fluorine-containing copolymers according to the invention include polyamides and polyesters. Specific examples of polyamides useful in practicing this invention are nylon 6, nylon 6/6, nylon 6/10, nylon 11 and nylon 12. Suitable polyesters include poly(ethylene terephthalate) and poly(butylene terephthalate) and their co-polymers with isophthalic acid or cyclohexanedimethanol. Best results have been observed when the host resin is a poly(ethylene terephthalate) homo- or co-polymer having an intrinsic viscosity of at least 0.6 dl/g, and preferably at least 0.7 dl/g.

Melt-processable polymers that can benefit from the invention can also contain an interfacial agent. The weight ratio of interfacial agent to fluoropolymer may range from 0.1 to 3.0 (but usually in the range of from 0.2 to 2.0). More than one interfacial agent may be employed, wherein the weight ratio of total interfacial agent to fluoropolymer is in the range of from 0.1 to 3.0.

By “interfacial agent” is meant a compound that is different from the fluoropolymer process aid and any host polymer and which is characterized by 1) being in the liquid state (or molten) at the extrusion temperature, 2) having a lower melt viscosity than the host polymer and fluoroelastomer, and 3) freely wets the surface of the fluoropolymer particles in the extrudable composition. Examples of such interfacial agents include, but are not limited to, i) silicone-polyether copolymers; ii) aliphatic polyesters such as poly(butylene adipate), poly(lactic acid) and polycaprolactone polyesters (preferably, the polyester is not a block copolymer of a dicarboxylic acid with a poly(oxyalkylene) polymer); iii) aromatic polyesters such as phthalic acid diisobutyl ester; iv) polyether polyols (preferably, not a polyalkylene oxide) such as poly(tetramethylene ether glycol); v) amine oxides such as octyldimethyl amine oxide; vi) carboxylic acids such as hydroxy-butanedioic acid; vii) fatty acid esters such as sorbitan monolaurate and triglycerides; and vii) poly(oxyalkylene) polymers. As used herein, the term “poly(oxyalkylene) polymers” refers to those polymers and their derivatives that are defined in U.S. Pat. No. 4,855,360. Such polymers include polyethylene glycols and their derivatives.

It is known (U.S. Pat. No. 6,642,310) that fluoropolymer process aids function by depositing a fluoropolymer coating on internal die surfaces, and that large particles transfer fluoropolymer mass to the die surface more quickly than small particles. In practicing the present invention, therefore, it is desirable to control the weight average particle size of the fluoropolymer process aid in the polymer composition which is to be extruded so that it is greater than 2 microns, but less than 10 microns, when the polymer reaches a point in the extrusion process immediately preceding the die (i.e., at the die entrance). For best results, the weight average particle size of the fluoropolymer should be greater than 4 microns, and even greater than 6 microns, as measured just prior to the die.

### Process Aid

Copolymers per the invention act as a good process aids by reason of greater extruder output and lower die pressure as can be seen from the Example which follows.

### EXAMPLE 6

The polymers prepared according to Examples 1 and 2 above (polymers 1 and 2, respectively) were used as process aids for LL1001.5, a linear low density polyethylene (LLDPE) ethylene-butene copolymer with a melt index of 1.0 dg/min available from Exxon-Mobil Corp. For comparison, a conventional fluoroelastomer process aid sold under the tradename Viton® FreeFlow™ 40 was also tested. This conventional fluoroelastomer process aid is a polymer of about 78 mol % VF₂ and 22 mol % HFP. The three fluoropolymers were first diluted to 5 wt % concentration in the LLDPE using a Brabender®) mixing bowl equipped with cam rotors. Each batch was mixed at 50 rpm for 3 minutes at a temperature set point of 200° C.

The three process aid masterbatches were allowed to cool, then granulated and mixed at 2 wt. % with pure LLDPE pellets to yield extrudable compositions comprising 1000 ppm of each of the fluoropolymer process aids in the LLDPE. The three extrudable compositions are shown in Table 1 below:

TABLE 1

| | EC-1 | EC-2 | EC-3 |
|---|---|---|---|
| Fluoropolymer | polymer 1 | polymer 2 | Viton ® FreeFlow 40 |
| concentration | 1000 ppm | 1000 ppm | 1000 ppm |

EC-1, EC-2, and EC-3 were extruded through a 2 mm diameter×40 mm long capillary die using a 19.05 mm diameter single screw extruder. The extruder screw consisted of 5 diameters of feed section, 5 diameters transition zone, and 15 diameters of metering, with an overall compression ratio of 3:1. The extruder was equipped with three temperature control zones for the barrel, and one for the die. The temperature set points were 200° C., 255° C., 250° C., and 250° C. from feed to exit.

Before each extrusion experiment, the extruder and die were thoroughly purged with a compound of diatomaceous earth in polyethylene (available from Ampacet Corp. as 807193) to remove any traces of fluoropolymer. The Ampacet compound was then purged with pure LLDPE. When baseline conditions of die pressure had been recovered, the extrudable composition under test was introduced to the extruder.

Each extrudable composition was extruded for two hours at a screw speed of 35 rpm. At the end of two hours, the extruder output and die pressure were recorded, then the screw speed was increased to 75 rpm. After a five minute equilibration period the extruder output and die pressure were recorded, and the same procedure was followed using a screw speed of 100 rpm.

Results of these experiments, shown in Table 2 below, indicate that in all cases the inventive compositions EC-1 and EC-2 provided greater extruder output and lower die pressure than conventional composition EC-3.

TABLE 2

| | EC-1 | | EC-2 | | EC-3 | |
|---|---|---|---|---|---|---|
| | Extruder | Die | Extruder | Die | Extruder | Die |
| | output | pressure | output | pressure | output | pressure |
| | (g/min) | (MPa) | (g/min) | (MPa) | (g/min) | (MPa) |
| 35 rpm | 15.7 | 15.4 | 15.1 | 16.8 | 14.4 | 19.6 |
| 75 rpm | 34.1 | 23.6 | 33 | 25 | 32.4 | 25.6 |
| 100 rpm | 45.4 | 27.2 | 44.3 | 28 | 43.5 | 28.6 |

### Barrier Performance and Adhesion

The identified fluorine-containing copolymers of this invention also perform very well as barrier layers in fuel containment applications, such as a liner in flexible hose constructions, because the copolymers adhere unexpectedly well to butadiene acrylonitrile (NBR) rubber.

### EXAMPLE 7

Polymer TFE-TFP-VF₂ (A) was prepared as described in Example 3 above. Dipolymer TFE-TFP (B) was prepared by aqueous semi-batch emulsion polymerization, carried out at 70° C. in a well-stirred reaction vessel. 24.0 kg of a 0.5 wt. % solution of perfluorohexylethylsulfonic acid was charged to a 33 L reactor and heated to 70° C. The reactor headspace was pressurized to 2.17 MPa with a first gaseous monomer mixture of 97 mole percent tetrafluoroethylene and 3 mole percent 3,3,3-trifluoropropene. Polymerization was commenced by adding 200 mL of a solution containing 7 wt. % ammonium persulfate/5 wt. % diammonium phosphate. The reactor pressure dropped in response to polymerization. Reactor pressure was maintained at 2.17 MPa by addition of a second gaseous monomer mixture of 84.5 mole percent tetrafluoroethylene, and 15.5 mole percent 3,3,3-trifluoropropene. Additional 7 wt. % ammonium persulfate/5 wt. % diammonium phosphate solution was added to maintain the polymerization. After 8000 grams of the second gaseous monomer mixture were added to the reactor, the reactor was cooled and depressurized to stop the polymerization. Cycle time (time between introduction of initiator and when 8000 g of the second gaseous monomer mixture had been added) was 13.8 hours. A 27.16 wt. % solids latex was obtained. The copolymer was coagulated by addition of aluminum sulfate and dried.

Sample slabs of each of the polymers were prepared by molding about 60 grams of each polymer for 5 minutes at 250° C. Permeation of each polymer to CE-10 hydrocarbon fuel was tested on the molded slabs by the Thwing Albert cup permeation test (ASTM E96). Adhesion to NBR rubber was tested by ASTM D413-82 using a 180° peel.

Results of permeation and adhesion tests are shown below in Table 3.

TABLE 3

Polymer

| | (A) | (B) |
|---|---|---|
| Permeation, g- | 1.2 | 1.2 |
| mm/m²/day | | |
| Adhesion, N/mm | 2.9 | 0.5 |
| Adhesion failure mode | Rubber tear | Bond line |

The results demonstrate that while both the TFE-TFP-VF2 copolymer (A) and the TFE-TFP dipolymer (B) exhibit equal permeation resistance to a typical automotive hydrocarbon fuel, the TFE-TFP-VF2 copolymer of the invention exhibits much higher adhesion to the NBR rubber substrate. The TFE-TFP-VF2 copolymer exhibited such unexpectedly high adhesion that the rubber substrate failed before the adhesive bond line did. High adhesion to NBR rubber substrates renders the above-defined copolymers very useful as barrier layers in fuel containment applications, such as liners in flexible hose constructions,

What is claimed is:

1. A copolymer consisting essentially of at least 50 mol percent up to 85 mol percent tetrafluoroethylene, from 10-35 mol percent 3,3,3-trifluoropropylene, and from 0.5-15 mol percent of a fluorinated ethylenically unsaturated monomer of the formula RCF=CR₂ wherein R, which can be the same or different, is selected from the group consisting of H, F, Cl, Br, I, alkyl of from 1 to 8 carbon atoms, perfluoroalkyl of from 1 to 8 carbon atoms, and perfluoroalkylether of from 1 to 8 carbon atoms.

2. The copolymer of claim 1 wherein said fluorinated ethylenically unsaturated monomers of the formula RCF═CR₂ are selected from the group consisting of vinylidene fluoride (VF2), hexafluoropropylene (HFP), perfluoro(alkyl vinyl ethers), 8-CNVE, perfluorobutyl ethylene, chlorotrifluoroethylene, 1-hydropentafluoropropylene, 2-hydropentafluoropropylene, bromotrifluoroethylene, iodotrifluoroethylene, 4-bromo-3,3,4,4-tetrafluorobutene, 4-iodo-3,3,4,4-tetrafluorobutene, and mixtures thereof.

3. The copolymer of claim 2 wherein said perfluoro(alkyl vinyl) ethers are defined by formula (I)
CF₂═CFO(R_{f′}O)ₙ(R_{f″}O)ₘR_{f} (I)
where R_{f′} and R_{f″} are different linear or branched perfluoroalkylene groups of 2-6 carbon atoms, m and n are independently 0-10, and R_{f} is a perfluoroalkyl group of 1-6 carbon atoms.

4. The copolymer of claim 2 wherein said perfluoro(alkyl vinyl) ethers are defined by formula (II)
CF₂═CFO(CF₂CFXO)ₙR_{f} (II)
where X is F or CF₃, n is 0-5, and R_{f} is a perfluoroalkyl group of 1-6 carbon atoms.

5. The copolymer of claim 4 wherein n is 0 or 1 and R_{f} contains 1-3 carbon atoms.

6. The copolymer of claim 2 wherein said perfluoro(alkyl vinyl) ethers are defined by formula (III)
CF₂═CFO[(CF₂)ₘCF₂CFZO]ₙR_{f} (III)
where R_{f} is a perfluoroalkyl group having 1-6 carbon atoms, m=0 or 1, n=0-5, and Z═F or CF₃.

7. The copolymer of claim 2 wherein said perfluoro(alkyl vinyl) ethers are defined by formula (IV)
CF₂=CFO[(CF₂CF{CF₃}O)ₙ(CF₂CF₂CF₂O)ₘ(CF₂)ₚ]CₓF₂ₓ₊₁ (IV)
where m and n independently=0-10, p=0-3, and x=1-5.

8. The copolymer of claim 2 wherein said perfluoro(alkyl vinyl) ethers are defined by formula (V)
CF₂═CFOCF₂CF(CF₃)O(CF₂O)ₘCₙF₂ₙ₊₁ (V)
where n=1-5, and m=1-3.

9. The copolymer of claim 1 consisting essentially of at least 50 mol percent up to 85 mol percent tetrafluoroethylene, from 10-35 mol percent 3,3,3-trifluoropropylene, and from 0.5-15 mol percent vinylidene fluoride (VF2).

10. A process for preparing copolymerized units of tetrafluoroethylene (TFE), 3,3,3-trifluoropropylene (TFP), and at least one other fluorinated ethylenically unsaturated monomer of the structure RCF═CR₂ wherein R, which can be the same or different, is selected from the group consisting of H, F, Cl, Br, I, alkyl of from 1 to 8 carbon atoms, perfluoroalkyl of from 1 to 8 carbon atoms, and perfluoroalkylether of from 1 to 8 carbon atoms which comprises:
(1) dispersing a first gaseous monomer mixture comprising 95-100 mole percent TFE and from 0-5 mole percent at least one other fluorinated ethylenically unsaturated monomer of the structure RCF=CR₂ as defined above into a reaction zone that contains an aqueous solution optionally comprising one or more of fluorosurfactant dispersing agent, pH buffer, polymerization initiator, and/or chain transfer agent at a temperature maintained in the range of 25° C.-130° C. so as to result in a pressure in the reaction zone of between 0.3 MPa and 10 MPa;
(2) adding additional quantities of gaseous monomers to the reaction zone at a controlled rate and at a relative ratio set to be approximately the same as the desired ratio of copolymerized monomer units in the resulting fluoropolymer to maintain the desired reactor pressure within the controlled temperature range, optionally while feeding additional flubrosurfactant dispersing agent, pH buffer, polymerization initiator, and/or chain transfer agent to the reaction zone, and
(3) isolating, filtering, washing, and drying the resulting polymer dispersion.

11. The process of claim 10 wherein the at least one other fluorinated ethylenically unsaturated monomer of the structure RCF=CR₂ is vinylidene fluoride (VF2).

12. An extrudable composition comprising a non-fluorinated, melt processable host polymer and from about 25 parts per million by weight to about 50% by weight, based on total weight of said extrudable composition, of a fluoropolymer consisting essentially of at least 50 mol percent up to 85 mol percent tetrafluoroethylene (TFE), from 10-35 mol percent 3,3,3-trifluoropropylene (TFP), and from 0.5-15 mol percent of at least one other fluorinated ethylenically unsaturated monomer of the formula RCF═CR₂ wherein R, which can be the same or different, is selected from the group consisting of H, F, Cl, Br, I, alkyl of from 1 to 8 carbon atoms, perfluoroalkyl of from 1 to 8 carbon atoms, and perfluoroalkylether of from 1 to 8 carbon atoms.

13. The extrudable composition of claim 12 consisting essentially of from 70-85 mol percent of TFE, from 15-30 mol percent TFP, and from 0.5-10 mol percent of said at least one other fluorinated ethylenically unsaturated monomer, and said at least one other fluorinated ethylenically unsaturated monomer is selected from the group consisting of vinylidene fluoride (VF2), hexafluoropropylene (HFP), perfluoro(alkyl vinyl ethers), 8-CNVE, perfluorobutyl ethylene, chlorotrifluoroethylene, 1-hydropentafluoropropylene, 2-hydropentafluoropropylene, bromotrifluoroethylene, iodotrifluoroethylene, 4-bromo-3,3,4,4-tetrafluorobutene, 4-iodo-3,3,4,4-tetrafluorobutene, and mixtures thereof.

14. The composition of claim 12 wherein the weight average particle size of the fluoropolymer in the extrudable polymer composition is greater than 2 microns, but less than 10 microns.

15. The composition of claim 13 wherein the weight average particle size of the fluoropolymer in the extrudable polymer composition is greater than 2 microns, but less than 10 microns.

16. A flexible hose construction having an interior tubular barrier layer comprising a copolymer consisting essentially of at least 50 mol percent up to 85 mol percent tetrafluoroethylene, from 10-35 mol percent 3,3,3-trifluoropropylene, and from 0.5-15 mol percent of a fluorinated ethylenically unsaturated monomer of the formula RCF═CR₂ wherein R, which can be the same or different, is selected from the group consisting of H, F, Cl, Br, I, alkyl of from 1 to 8 carbon atoms, perfluoroalkyl of from 1 to 8 carbon atoms, and perfluoroalkylether of from 1 to 8 carbon atoms.

17. The flexible hose construction of claim 16 in which the fluorinated ethylenically unsaturated monomer of the formula RCF═CR₂ is vinylidene fluoride (VF2).

18. A method for improving extrusion characteristics of a non-fluorinated melt-processable polymer comprising incorporating into said polymer from about 25 parts per million by weight to about 50% by weight, based on total weight of said polymer, of a copolymer consisting essentially of at least 50 mol percent up to 85 mol percent tetrafluoroethylene, from 10-35 mol percent 3,3,3-trifluoropropylene, and from 0.5-15 mol percent of a fluorinated ethylenically unsaturated monomer of the formula RCF═CR₂ wherein R, which can be the same or different, is selected from the group consisting of H, F, Cl, Br, I, alkyl of from 1 to 8 carbon atoms, perfluoroalkyl of from 1 to 8 carbon atoms, and perfluoroalkylether of from 1 to 8 carbon atoms.

19. The method of claim 18 wherein the copolymer consists essentially of at least 50 mol percent up to 85 mol percent tetrafluoroethylene, from 10-35 mol percent 3,3,3-trifluoropropylene, and from 0.5-15 mol percent vinylidene fluoride (VF2).
